(19) United States
(12) Patent Application Publication
(10) Pub. No.: US 2013/0212481 A1
(43) Pub. Date: Aug. 15, 2013

(54) METHOD AND APPARATUS FOR CONTROLLING INTERFACE DISPLAY, AND COMMUNICATION TERMINAL

(71) Applicants: Beijing Lenovo Software Ltd, (US); Lenovo (Beijing) Co., Ltd., (US)

(72) Inventors: Rui Zhu, Beijing (CN); Bo Zhang, Beijing (CN); Chunlei Zhao, Beijing (CN)

(73) Assignees: Lenovo (Beijing) Co., Ltd., Beijing (CN); Beijing Lenovo Software Ltd, Beijing (CN)

(21) Appl. No.: 13/756,857

(22) Filed: Feb. 1, 2013

(30) Foreign Application Priority Data
Feb. 10, 2012 (CN) 201210030484.5

(51) Int. Cl. G06F 3/0484

(52) U.S. Cl. CPC G06F 3/0484
USPC 715/738

(57) ABSTRACT

A method for controlling interface display includes: detecting an operation status of a first communication terminal; detecting a first event, in a case that the operation status of the first communication terminal is a first status in which there is a request for a communication connection between the first communication terminal and a second communication terminal; determining whether the first event associated with a communication status between the first communication terminal and second communication terminal conforms to a predetermined trigger condition; controlling a display of a scenario interface corresponding to the predetermined trigger condition according to a predetermined corresponding relation between the trigger condition and the scenario interface if it is determined that the first event conforms to the trigger condition.

This application claims the priority of Chinese Patent Application 201210030484.5 entitled “METHOD AND APPARATUS FOR CONTROLLING INTERFACE DISPLAY, AND COMMUNICATION TERMINAL”, filed on Feb. 10, 2012 with State Intellectual Property Office of PRC. The aforementioned application is herein incorporated by reference in its entirety.

### FIELD OF THE INVENTION

The present invention relates to the technical field of mobile communication, and particularly to a method and apparatus for controlling interface display and a communication terminal.

### BACKGROUND OF THE INVENTION

Mobile phone is widely used with the development of mobile communication technology. Answering and dialing a call are the most common applications in daily life. In the prior art, generally, a mobile phone can only return to an interface of call initiating after the incoming call is hung up or rejected by a subscriber. If the mobile phone is required to enter other interfaces according to requirements of the subscriber, the mobile phone firstly needs to exit from the interface of call initiating and then enter the required interface by manual operation of the subscriber who may then do corresponding operations. The mode described above, in which the mobile phone is not capable of returning to the corresponding interface intelligently, is inconvenient for the operations of the subscriber.

### SUMMARY OF THE INVENTION

In order to solve the technical problems described above, the embodiments of the present invention provides a method and apparatus for controlling interface display and a communication terminal, for displaying different interfaces according to a specific event statuses, and thus satisfying user requirements. The technical solutions are as follows.

In one aspect, an embodiment of the present invention discloses a method for controlling interface display, which is applied to a first communication terminal, and the method includes:

detecting an operation status of the first communication terminal;

detecting a first event in a case that the operation status of the first communication terminal is a first status in which there is a request for a communication connection between the first communication terminal and a second communication terminal;

determining whether the first event associated with a communication status between the first communication terminal and the second communication terminal conforms to a predetermined trigger condition;

controlling a display of a scenario interface corresponding to the predetermined trigger condition according to a predetermined corresponding relation between the trigger condition and the scenario interface if it is determined that the first event conforms to the trigger condition.

Preferably, the status in which there is the request for the communication connection between the first communication terminal and the second communication terminal is:

a status in which the first communication terminal initiates a request for establishing a communication connection with the second communication terminal.

Preferably, the communication status between the first communication terminal and the second communication terminal includes:

a status in which the communication connection is disconnected after the communication connection is successfully established between the first and the second communication terminals; or

a status in which the communication connection fails to be established between the first and the second communication terminals.

Preferably, when the communication status between the first communication terminal and the second communication terminal is detected as the status in which the communication connection is disconnected after the communication connection is successfully established between the first and the second communication terminals, controlling the display of the scenario interface corresponding to the trigger condition, according to the predetermined corresponding relation between the trigger condition and the scenario interface includes:

controlling a display of a first scenario interface which is a main operation interface.

Preferably, the status in which the communication connection fails to be established between the first and the second communication terminals includes any one of:

a status in which the first communication terminal triggers to give up the request for establishing the communication connection;

a status in which the second communication terminal triggers to refuse the request for establishing the communication connection;

a status in which a network communication device triggers to disconnect the request for the communication connection.

Preferably, when the status in which the communication connection fails to be established between the first and the second communication terminals is the status in which the first communication terminal triggers to give up the request for establishing the communication connection, or the status in which the network communication device triggers to disconnect the request for the communication connection, controlling the display of the scenario interface corresponding to the trigger condition, according to the predetermined corresponding relation between the trigger condition and the scenario interface includes:

controlling a display of a second scenario interface which is a dialing interface, an address book interface, a communication history interface or any combination thereof.

Preferably, when the status in which the communication connection fails to be established between the first and the second communication terminals is the status in which the second communication terminal triggers to refuse the request for establishing the communication connection, controlling the display of the scenario interface corresponding to the trigger condition, according to the predetermined corresponding relation between the trigger condition and the scenario interface includes:

controlling a display of a third scenario interface which is a short message editing interface, a mail editing interface or an instant communication software interface.

Preferably, the status in which there is the request for the communication connection between the first communication terminal and the second communication terminal is:

a status in which the first communication terminal receives a request for establishing a communication connection initiated by the second communication terminal.

Preferably, when the communication status between the first communication terminal and the second communication terminal is a status in which the first communication terminal rejects the request for establishing the communication connection initiated by the second communication terminal, controlling the display of the scenario interface corresponding to the trigger condition, according to the predetermined corresponding relation between the trigger condition and the scenario interface includes:

controlling a display of a predetermined fourth scenario interface, and performing a second operation.

Preferably, the performing the second operation includes:

accepting a selecting operation of a subscriber, and sending a short message with a content corresponding to the selecting operation of the subscriber to the second communication terminal; or

sending a short message with a predetermined content to the second communication terminal.

Preferably, the method further includes, after it is determined that the first event conforms to the predetermined trigger condition, and before controlling a display of a scenario interface corresponding to the predetermined trigger condition according to a predetermined corresponding relation between the trigger condition and the scenario interface:

determining the scenario interface to be displayed further according to auxiliary information.

On the other hand, an embodiment of the present invention discloses an apparatus for controlling interface display which is provided in a first communication terminal, and the apparatus includes:

a first detecting unit, configured to detect an operation status of the first communication terminal;

a second detecting unit, configured to detect a first event when the operation status of the first communication terminal is a first status in which there is a request for a communication connection between the first communication terminal and the second communication terminal;

a determining unit, configured to determine whether the first event associated with a communication status between the first communication terminal and the second communication terminal conforms to a predetermined trigger condition;

a display control unit, configured to control a display of a scenario interface corresponding to a predetermined trigger condition according to the predetermined corresponding relation between the trigger condition and the scenario interface if it is determined that the first event conforms to the trigger condition.

Preferably, the status in which there is the request for the communication connection between the first communication terminal and the second communication terminal is:

a status in which the first communication terminal initiates a request for establishing a communication connection with the second communication terminal.

Preferably, the determining unit is:

a first determining unit, configured to determine whether the communication status between the first communication terminal and the second communication terminal is a status in which the communication connection is disconnected after the communication connection is successfully established between the first and the second communication terminals;

the display control unit is:

a first display control unit, configured to receive a determined result from the first determining unit, and control a display of a first scenario interface which is a main operation interface.

Preferably, the determining unit is:

a second determining unit, configured to determine whether the communication status between the first communication terminal and the second communication terminal is a status in which the first communication terminal triggers to give up the request for establishing the communication connection, or a status in which a network communication device triggers to disconnect the request for the communication connection;

the display control unit is:

a second display control unit, configured to receive a determined result from the second determining unit, and control a display of a second scenario interface which is a dialing interface, an address book interface, a communication history interface or any combination thereof.

Preferably, the determining unit is:

a third determining unit, configured to determine whether the communication status between the first communication terminal and the second communication terminal is a status in which the second communication terminal triggers to refuse the request for establishing the communication connection;

the display control unit is:

a third display control unit, configured to receive a determined result from the third determining unit, and control a display of a third scenario interface which is a short message editing interface, a mail editing interface or an instant communication software interface.

Preferably, the status in which there is a request for the communication connection between the first communication terminal and the second communication terminal is:

a status in which the first communication terminal receives a request for establishing a communication connection initiated by the second communication terminal.

Preferably, the determining unit is:

a fourth determining unit, configured to determine whether the communication status between the first communication terminal and the second communication terminal is a status in which the first communication terminal rejects the request for establishing the communication connection initiated by the second communication terminal;

the display control unit is:

a fourth display control unit, configured to receive a determined result from the fourth determining unit, and control a display of a predetermined fourth scenario interface.

Preferably, the apparatus further includes:

a first executing unit, configured to accept a selecting operation of a subscriber, and send a short message with a content corresponding to the selecting operation of the subscriber to the second communication terminal; and

a second executing unit, configured to send a short message with a predetermined content to the second communication terminal.

In yet another aspect, an embodiment of the present invention further discloses a communication terminal, and the communication terminal includes:

a display module, configured to display a scenario interface;

a communication module, configured to establish a communication connection with a second communication terminal and communicate;

a control module, configured to detect an operation status of the communication terminal; to detect a first event when the operation status of the communication terminal is a first status in which there is a request for a communication connection between the communication module and a second communication terminal; to determine whether the first event associated with a communication status between the communication module and the second communication terminal conforms to a predetermined trigger condition; to control the display module to display a scenario interface corresponding to the predetermined trigger condition according to a predetermined corresponding relation between the trigger condition and the scenario interface if it is determined that the first event conforms to the trigger condition.

The advantageous effect of the embodiments of the present invention is that: the corresponding relation between the trigger condition and the scenario interface is established in advance; a first event is detected when an operation status of a first communication terminal is detected as a first status; whether the first event conforms to a predetermined trigger condition is determined; controlling may be performed to display a scenario interface corresponding to the predetermined trigger condition according to a predetermined corresponding relation between the trigger condition and the scenario interface if it is determined that the first event conforms to the trigger condition. Due to the established corresponding relation between the trigger condition and the scenario interface, different scenario interfaces can be displayed according to different requirements if it is detected that the first event conforms to the trigger condition. With the method according to the present invention, the amount of the operations of a subscriber is reduced, and different application scenario interfaces are allowed to be displayed according to different trigger conditions. The method is simple for implementation and convenient for usage.

### BRIEF DESCRIPTION OF THE DRAWINGS

The drawings to be used in the description will be described briefly as follows, so that the technical solutions according to the embodiments of the present invention will become clearer. It is obvious that the drawings in the following description are only some embodiments of the present invention. For those skilled in the art, other drawings can be obtained according to these drawings without any creative effort.

FIG. 1 is a flowchart of a method for controlling interface display according to a first embodiment of the present invention;

FIG. 2 is a flowchart of a method for controlling interface display according to a second embodiment of the present invention;

FIG. 3 is a flowchart of a method for controlling interface display according to a third embodiment of the present invention;

FIG. 4 is a flowchart of a method for controlling interface display according to a fourth embodiment of the present invention;

FIG. 5 is a flowchart of a method for controlling interface display according to a fifth embodiment of the present invention;

FIG. 6 is a flowchart of a method for controlling interface display according to a sixth embodiment of the present invention;

FIG. 7 is a schematic diagram of an apparatus for controlling interface display according to an embodiment of the present invention; and

FIG. 8 is a schematic diagram of a communication terminal according to an embodiment of the present invention.

### DETAILED DESCRIPTION OF THE INVENTION

The embodiments of the present invention provide a method and apparatus for controlling interface display and a communication terminal, for displaying different application interfaces according to a specific event status, so as to satisfy requirements of a subscriber.

The technical solution according to the embodiments of the present invention will be described clearly and completely as follows in conjunction with the drawings. It is obvious that the described embodiments are only some of the embodiments according to the present invention. Other embodiments obtained by those skilled in the art based on the embodiments in the present invention without any creative effort fall into the scope of the present invention.

The method for controlling interface display according to the embodiment of the present invention can be applied in a first communication terminal, which can be a communication device such as a mobile phone.

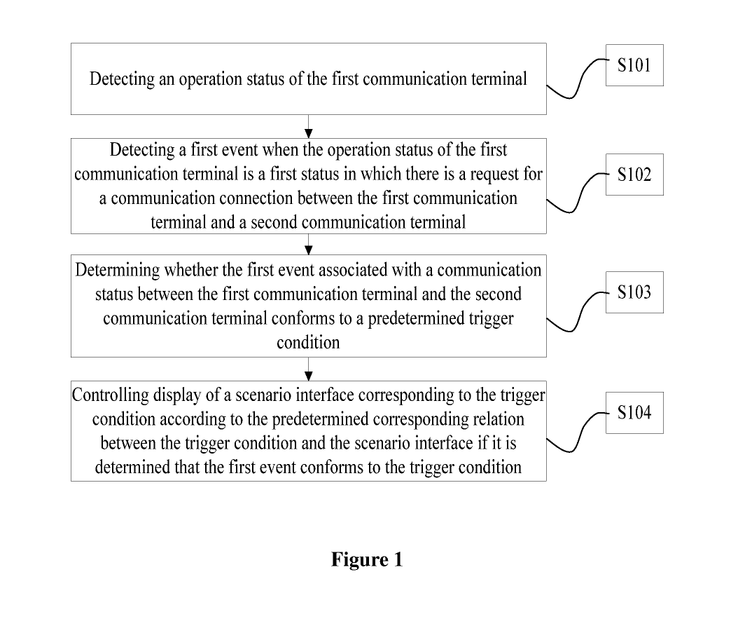

Reference is made to FIG. 1 which is a flowchart of the method for controlling interface display according to a first embodiment of the present invention. The method includes:

S101, detecting an operation status of the first communication terminal.

S102, detecting a first event when the operation status of the first communication terminal is a first status in which there is a request for a communication connection between the first communication terminal and a second communication terminal.

Specifically, the first status, in which there is the request for the communication connection between the first communication terminal and the second communication terminal, includes:

(1) a status in which the first communication terminal initiates a request for establishing the communication connection with the second communication terminal;

(2) a status in which the first communication terminal receives a request for establishing the communication connection initiated by the second communication terminal.

S103, determining whether the first event associated with a communication status between the first communication terminal and the second communication terminal conforms to a predetermined trigger condition.

When the first status of the first communication terminal is the status in which the first communication terminal initiates the request for establishing the communication connection with the second communication terminal, the communication status between the first communication terminal and the second communication terminal includes:

(1) a status in which the communication connection is disconnected after the communication connection is successfully established between the first and the second communication terminals;

(2) a status in which the communication connection fails to be established between the first and the second communication terminals, which may in turn include any one of the following:

A, a status in which the first communication terminal triggers to give up the request for establishing the communication connection;

B, a status in which the second communication terminal triggers to refuse the request for establishing the communication connection; and

C, a status in which a network communication device triggers to disconnect the request for the communication connection. Here, the network communication device may be an intermediate device such as a base station (BS) and a mobile switching center (MSC). The request for the communication connection may be disconnected by the intermediate device initiatively in the case that the signal is weak, the second communication terminal is power off, the second communication terminal is busy or the waiting time is too long.

When the first status of the first communication terminal is the status in which the first communication terminal receives the request for establishing the communication connection initiated by the second communication terminal, the communication status between the first communication terminal and the second communication terminal includes:

(1) a status in which the communication connection is disconnected after the communication connection is successfully established between the first and the second communication terminals;

(2) a status in which the communication connection fails to be established between the first and the second communication terminals, which may in turn include any one of the following:

A, a status in which the first communication terminal triggers to refuse the request for establishing the communication connection; and

B, a status in which the network communication device triggers to disconnect the request for the communication connection.

Corresponding to the various communication statuses between the first communication terminal and the second communication terminal, the first event may includes any one of the following:

an event in which the communication connection is disconnected after the communication connection is successfully established between the first and the second communication terminals;

an event in which the first communication terminal triggers to give up the request for establishing the communication connection;

an event in which the second communication terminal triggers to refuse the request for establishing the communication connection; and an event in which the network communication device triggers to disconnect the request for the communication connection.

S104, controlling a display of a scenario interface corresponding to the predetermined trigger condition according to the predetermined corresponding relation between the trigger condition and the scenario interface if it is determined that the first event conforms to the trigger condition.

In the embodiment of the present invention, the corresponding relation between the trigger condition and the scenario interface is established in advance. When it is determined that the first event conforms to the predetermined trigger condition, a display unit of the first communication terminal is controlled to display a scenario interface corresponding to the trigger condition, according to the corresponding relation between the trigger condition and the scenario interface.

In a first embodiment of the present invention, the operation status of the first communication terminal is detected, and when the operation status of the first communication terminal is detected as the first status the first event is detected; it is determined whether the first event conforms to the predetermined trigger condition; and when it is determined that the first event conforms to the trigger condition, a display of the scenario interface corresponding to the predetermined trigger condition is controlled according to the predetermined corresponding relation between the trigger condition and the scenario interface. Since the corresponding relation between the trigger conditions and the application scenarios is established in advance, different scenario interfaces may be displayed according to different requirements when the detected first event conforms to the trigger condition. With the method according to the present invention, the amount of the operations of a subscriber is reduced, and different application scenario interfaces are allowed to be displayed according to different trigger conditions. The method is simply for implementation and convenient for usage.

In the following, the method for controlling interface display according to the present invention will be described in detail in conjunction with several embodiments, and all of the illustrated embodiments are the extended or improved versions of the embodiment shown in FIG. 1.

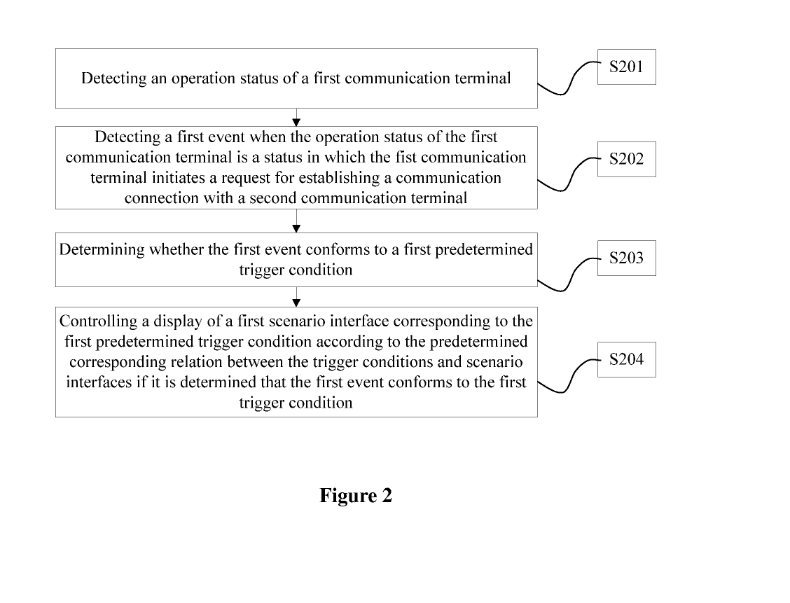

Reference is made to FIG. 2, which is a flowchart of the method for controlling interface display according to a second embodiment of the present invention.

S201, detecting an operation status of a first communication terminal.

S202, detecting a first event when the operation status of the first communication terminal is a status in which the first communication terminal initiates a request for establishing a communication connection with a second communication terminal.

S203, determining whether the first event conforms to a first predetermined trigger condition.

In the second embodiment of the present invention, whether the first event conforms to the first predetermined trigger condition is determined according to the communication status between the first communication terminal and the second communication terminal. It is determined that the first event confirms to the first predetermined trigger condition when the communication status between the first communication terminal and the second communication terminal is the status in which the communication connection is disconnected after the communication connection is successfully established between the first and the second communication terminals. Specifically, the system determines that the communication status between the first communication terminal and the second communication terminal is the status in which the communication connection is disconnected after the communication connection is successfully established between the first and the second communication terminals based on an instruction returned according to a Communication Network Protocol. In the Communication Network Protocol, a corresponding instruction may be returned when a communication is disconnected after the communication is connected successfully, with which the current status between the first communication terminal and the second communication terminal can be determined. In the following, one specific example is given. After a mobile phone is connected, an instruction PHONE.CONNECTED may be reported, with which the system may known that the mobile phone has been connected; when the mobile phone is hung up, an instruction PHONE.HANGUP may be reported, with which the system may known that the mobile phone has been hung up. If the first communication terminal receives the instruction PHONE.HANGUP after receiving the instruction PHONE.CONNECTED, it can be determined that the communication status between the first communication terminal and the second communication terminal is the status in which the communication connection between the first communication terminal and the second communication terminal is disconnected after the communication connection is established successfully. If the first communication terminal receives the instruction PHONE.HANGUP without receiving the instruction PHONE.CONNECTED, it can be determined that the communication connection is disconnected between the first communication terminal and the second communication terminal without being successfully established.

S204, controlling a display of a first scenario interface corresponding to the first predetermined trigger condition according to the predetermined corresponding relation between the trigger conditions and scenario interfaces if it is determined that the first event conforms to the first trigger condition.

Since the first communication terminal disconnects the communication connection with the second communication terminal after the communication connection is established successfully, in the second embodiment, it is controlled to display the first scenario interface according to the corresponding relation between the trigger condition and the scenario interface, so as to facilitate other operations of the subscriber. Specifically, the first scenario interface is a main operation interface. Here, the main operation interface is a first interface displayed after a communication terminal is powered on, and can also be referred to as a desktop, a main interface of the communication terminal or the like.

In the embodiment of the present invention, the first communication terminal returns to the main operation interface only when it is determined that the communication status between the first communication terminal and the second communication terminal is the status in which the communication connection is disconnected after the communication connection is established successfully. In the following, the embodiment in which a corresponding scenario interface is displayed when the communication connection fails to be established between the first and the second communication terminals will be described in detail.

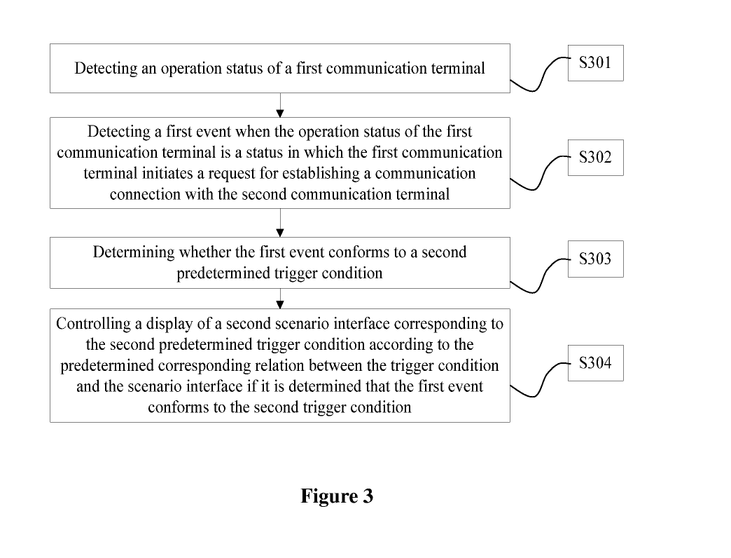

Reference is made to FIG. 3, which is a flowchart of the method for controlling interface display according to a third embodiment of the present invention.

S301, detecting an operation status of a first communication terminal;

S302, detecting a first event when the operation status of the first communication terminal is a status in which the first communication terminal initiates a request for establishing a communication connection with the second communication terminal.

S303, determining whether the first event conforms to a second predetermined trigger condition.

In the third embodiment of the present invention, whether the first event conforms to the second predetermined trigger condition is determined according to the communication status between the first communication terminal and the second communication terminal. It is determined that the first event confirms to the second predetermined trigger condition when the communication status between the first communication terminal and the second communication terminal is the status in which the first communication terminal triggers to give up the request for establishing the communication connection with the second communication terminal, or the status in which the communication connection with the second communication terminal is disconnected because a network communication device triggers to disconnect the request for the communication connection. Specifically, the system determines the communication status between the first communication terminal and the second communication terminal based on the signaling returned according to the Communication Network Protocol. According to the Communication Network Protocol, a corresponding signaling may be returned by network operators when a communication connection is disconnected, that is, when the phone is hung up. And according to the returned signaling value, a specific communication status such as normal hang-up, failing to be connected, being refused by the other side or phone busy (busy) may be determined. Different signaling may be returned in different networks, and determination needs to be performed accordingly. In another embodiment of the present invention, the specific communication status may be determined based on speech recognition performed on the speech information returned when the communication connection is established. For example, the returned speech information is “the subscriber you dialed is power off” if the intended mobile phone is power off; the returned speech information is “the subscriber you dialed is busy now” if the intended mobile phone is busy; and the returned speech information is “the subscriber you dialed does not answer, please redial later” if the phone is not answered for a long time, or the like. The communication status between the first communication terminal and the second communication terminal may be determined by identifying the returned speech information, and then whether the first event conforms to the predetermined trigger condition may be determined.

In the embodiment of the present invention, the reason for the status in which the first communication terminal triggers to give up the request for establishing the communication connection with the second communication terminal, may be the non-response from the second communication terminal for a long time, a power off status of the second communication terminal, or a busy status of the second communication terminal. In this case, by detecting a hang-up operation of the first communication terminal, it may be determined that the first communication terminal initiatively triggers to give up the request for establishing the communication connection with the second communication terminal.

The case, in which the network communication device triggers to disconnect the request for the communication connection, may include: a weak signal, an over-long waiting time, a power off status of the other side, non-response of the other side for a long time, or the like. Determination may be made according to the signaling returned in the Communication Network Protocol by the network operators.

S304, controlling a display of a second scenario interface corresponding to the second predetermined trigger condition according to the predetermined corresponding relation between the trigger condition and the scenario interface if it is determined that the first event conforms to the second trigger condition.

The second scenario interface can be a dialing interface, an address book interface, a communication history interface, a short message editing interface or any combination thereof. In the case that the first communication terminal initiates the request for establishing the communication connection with the second communication terminal, if the communication connection is disconnected by the first communication terminal initiatively due to non-response of the second communication terminal for a long time or a busy status of the second communication terminal, or, if the communication connection is disconnected by the intermediate network communication device (BS, MSC, or the like) due to a weak signal or an over-long waiting time, the subscriber may want to re-establish the communication connection with the second communication terminal, thus the dialing interface may be displayed so as to facilitate redialing by the subscriber.

Correspondingly, the address book interface may also be displayed. Since the disconnect of the request for the communication connection is triggered by the first communication terminal initiatively or by the network communication device, the communication connection fails to be established between the first and the second communication terminals, and then the subscriber with the first communication terminal may want to re-establish the connection with the second communication terminal. Therefore, the address book interface may be displayed so as to facilitate the dialing of the subscriber. Further, all contact information of the second communication terminal may be acquired and displayed in the second interface alone or in a prioritized way. Further, the contact information other than the information used for establishing the connection for the first time may be displayed in the second interface in a prioritized way. For example, in the case that the first communication terminal initiates a request for establishing the communication connection with the second communication terminal by dialing a mobile phone number of the second communication terminal, the contact information of the second communication terminal other than the mobile phone number, such as a landline number and a personal access system (PAS) number of the second communication terminal, may be displayed in the second interface in a prioritized way.

Correspondingly, the communication history interface may be dispplayed, so as to facilitate the redialing of the subscriber. Further, in a possible embodiment, the second interface may be a combination of any two of the above interfaces, for example the combination of the dialing interface and the communication history interface, which is not limited in the present invention.

Correspondingly, controlling may be performed to display the mail editing interface or the instant massaging software interface. In the case that the first communication terminal initiatively triggers to give up the request for establishing the communication connection or the network communication device triggers to disconnect the request for the communication connection because the intended terminal is power off, the subscriber with the first communication terminal may want to contact with the second communication terminal by other ways, then the mail editing interface or the instant communication software interface may be displayed to facilitate contacting the subscriber with the second communication terminal. Specifically, after detecting the hang-up operation of the first communication terminal, it may be further determined whether the communication connection is disconnected because the second communication terminal is power off according to the signaling value returned by the network operators. If it is determined that the communication connection is disconnected because the second communication terminal is power off, the mail editing interface or the instant communication software interface is displayed according to the corresponding relation between the trigger condition and the scenario interface. Furthermore, in the case that the communication connection is disconnected because the second communication terminal is power off, the interface to be displayed may be further determined according to auxiliary information. Specifically, the auxiliary information may be information of time, for example, a period of time may be preset in advance, and if the current time is later than twelve o'clock in the evening, the main operation interface, instead of the mail editing interface, a callback interface, or the like, is displayed.

In the third embodiment of the present invention, after the first communication terminal initiates the request for establishing the connection with the second communication terminal, in the case that due to the non-response of the second communication terminal, the first communication terminal triggers to disconnect the request for the communication connection or the network communication device triggers to disconnect the request for the communication connection, controlling may be performed to display the second scenario interface which may be a dialing interface, an address book interface, a communication history interface or any combination thereof. Thus, it is convenient for a client to establish a connection with the second communication terminal again, which facilitates user utilization and satisfies user requirements.

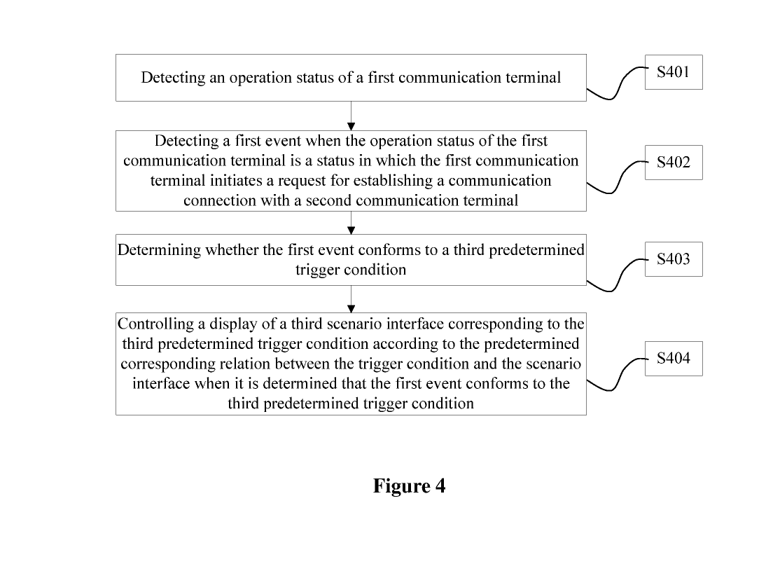

Reference is made to FIG. 4, which is a flowchart of the method for controlling interface display according to a fourth embodiment of the present invention.

S401, detecting an operation status of a first communication terminal.

S402, detecting a first event when the operation status of the first communication terminal is a status in which the first communication terminal initiates a request for establishing a communication connection with a second communication terminal.

S403, determining whether the first event conforms to a third predetermined trigger condition.

In the fourth embodiment of the present invention, whether the first event conforms to the third predetermined trigger condition is determined according to a communication status between the first communication terminal and the second communication terminal. It is determined that the first event confirms to the third predetermined trigger condition when the communication status between the first communication terminal and the second communication terminal is the status in which the second communication terminal triggers to refuse the request for establishing the communication connection. As mentioned above, after the phone is answered, the instruction PHONE.CONNECTED may be reported, with which the system may known that the mobile phone has been connected; and when the mobile phone is hung up, the instruction PHONE.HANGUP may be reported, with which the system may known that the mobile phone has been hung up. If the first communication terminal receives the instruction PHONE.HANGUP without receiving the instruction PHONE.CONNECTED, it can be determined that the communication connection is disconnected after the communication connection is successfully established between the first and the second communication terminals. Further, the system may further make the decision according to a talk time contained in the returned signaling event. If the talk time in the returned signaling is zero or none value, it can be determined that the communication connection is disconnected between the first communication terminal and the second communication terminal without being successfully established due to the reason that the second communication terminal refuses the phone call.

S404, controlling a display of a third scenario interface corresponding to the third predetermined trigger condition according to the predetermined corresponding relation between the trigger condition and the scenario interface when it is determined that the first event conforms to the third predetermined trigger condition.

The third scenario interface is a short message editing interface, a mail editing interface or an instant communication software interface. In the case that the first communication terminal initiates the request for establishing the communication connection with the second communication terminal, when the second communication terminal initiatively triggers to disconnect the request for the communication connection, that is, the second communication terminal refuses to answer the phone, the subscriber may want to contact with the second communication terminal by a short message, a mail, or the like. Thus, controlling may be performed to display the short message editing interface, the mail editing interface, the instant message software interface (e.g. QQ, MSN) or the like.

Further, the contact information of the person corresponding to the second communication terminal is acquired and added into the third scenario interface. For example, a mobile phone number of the person corresponding to the second communication terminal is acquired and added into the addressee number option in the short message editing interface, so that the subscriber has no need to find out or add the addressee number manually. For another example, a mail address of the person corresponding to the second communication terminal is acquired and added into the address bar in the mail editing interface, so that the subscriber has no need to fill the mail address manually. For yet another example, other account numbers such as a QQ number and a MSN number of the person corresponding to the second communication terminal are acquired, and the chatting history interface with the person corresponding to the second communication terminal may be further acquired after logging in the instant communication software, and the editing interface for chatting with the person corresponding to the second communication terminal is directly displayed in the lower window.

In the fourth embodiment of the present invention, after the first communication terminal initiates the request for establishing the communication connection with the second communication terminal, the third scenario interface, which may be a short message editing interface, a mail editing interface, an instant communication software interface or the like, is displayed in the case that the request for the communication connection is disconnected due to the reason that the second communication terminal refuses the call. Thus, the client can contact with the second communication terminal by other communication ways, which facilitates user utilization and satisfies user requirements.

In the following, several embodiments, in which the operation status of the first communication terminal is the status in which the first communication terminal receives the request for establishing the communication connection initiated by the second communication terminal, will be described in detail.

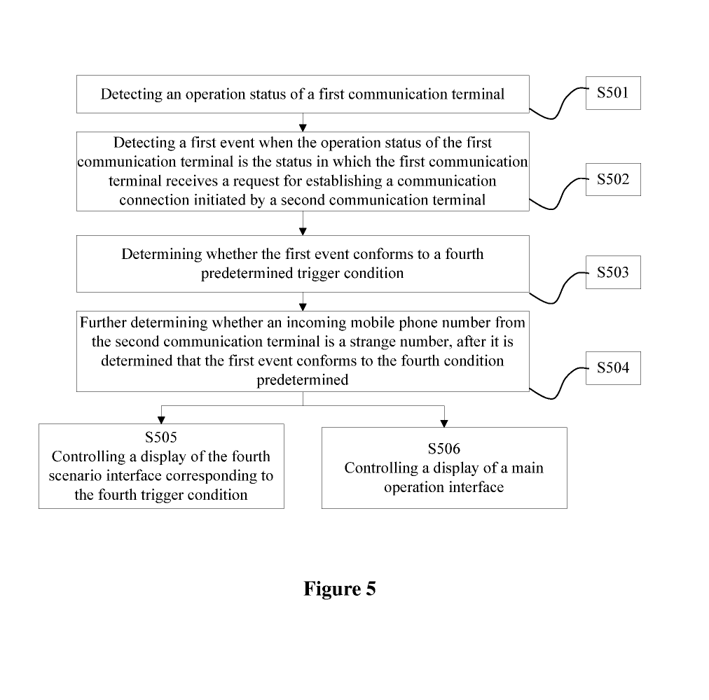

Reference is made to FIG. 5, which is a flowchart of the method for controlling interface display according a fifth embodiment of to the present invention.

S501, detecting an operation status of a first communication terminal.

S502, detecting a first event when the operation status of the first communication terminal is the status in which the first communication terminal receives a request for establishing a communication connection initiated by a second communication terminal.

S503, determining whether the first event conforms to a fourth predetermined trigger condition.

In the fifth embodiment of the present invention, whether the first event conforms to the fourth predetermined trigger condition is determined according to a communication status between the first communication terminal and the second communication terminal. It is determined that the first event confirms to the fourth predetermined trigger condition when the communication status between the first communication terminal and the second communication terminal is a status in which the first communication terminal rejects the request for the communication connection from the second communication terminal.

Specifically, a second operation of the first communication terminal may be detected; it is determined that the first event satisfies the fourth predetermined trigger condition when the second operation is pressing the hang-up key and therefore it is determined that the second operation conforms to the trigger condition.

S504, further determining whether an incoming mobile phone number from the second communication terminal is a strange number, after it is determined that the first event conforms to the fourth condition predetermined. If the incoming mobile phone number of the second communication terminal is a strange number, the process proceeds to S506; or, the process proceeds to S505.

Specifically, whether the incoming mobile phone number from the second communication terminal is a strange number may be determined by comparing the incoming mobile phone number with the phone numbers in the address book of the first communication terminal. If the incoming mobile phone number is a strange number, the process proceeds to S506 directly, that is, a main operation interface is displayed. If the incoming mobile phone number is not a strange number, a fourth scenario interface which is a short messaging interface, a short message selecting interface, a sending confirmation interface or the like may be displayed.

S505, controlling a display of the fourth scenario interface corresponding to the fourth trigger condition according to the predetermined corresponding relation between the trigger condition and the scenario interface.

In the case of hanging up the phone call when it is not convenient for the subscriber with the first communication terminal to answer the phone call, controlling may be performed to display the fourth scenario interface, which may be a short message editing interface so that the subscriber may conveniently send a corresponding short message for explaining the reason of the hang-up to the second communication terminal.

The fourth scenario interface may also be an interface for displaying a preset short message list. Specifically, several response messages, such as “I am in meeting”, “I am in class”, “I am not convenient to answer and will call you later”, may be preset by the terminal or the subscriber, and the subscriber may decide which short message is to be send to the second communication terminal. Further, a second operation, which is to receive the selecting operation of the subscriber and send a short message of a content corresponding to the selecting operation of the subscriber to the second communication terminal, is performed after the fourth scenario interface, i.e., the short message selecting interface, is displayed.

The fourth scenario interface may be the sending confirmation interface. Specifically, a default short message sent when a phone call is rejected may be set by the subscriber. The fourth scenario interface including the default short message and the contact information of the second communication terminal is displayed directly after the first event occurs, and whether the message should be sent is determined by the subscriber. After receiving the confirmation operation of the subscriber, the first communication terminal sends the default short message with the predetermined content to the second communication terminal.

S506, controlling a display of a main operation interface.

In the fifth embodiment of the present invention, after the first communication terminal receives the request for establishing the communication connection initiated by the second communication terminal, in the case that the first communication terminal rejects the phone call and the request for communication connection is disconnected, controlling may be performed to display the fourth scenario interface, which may be a short message editing interface, a short message selecting interface, a sending confirmation interface or the like. Thus, it is convenient for the client to notify the subscriber with the second communication terminal the reason of rejecting the call by sending a short message, so that the unnecessary misunderstood and bad feeling of the subscriber with the second communication terminal is avoided.

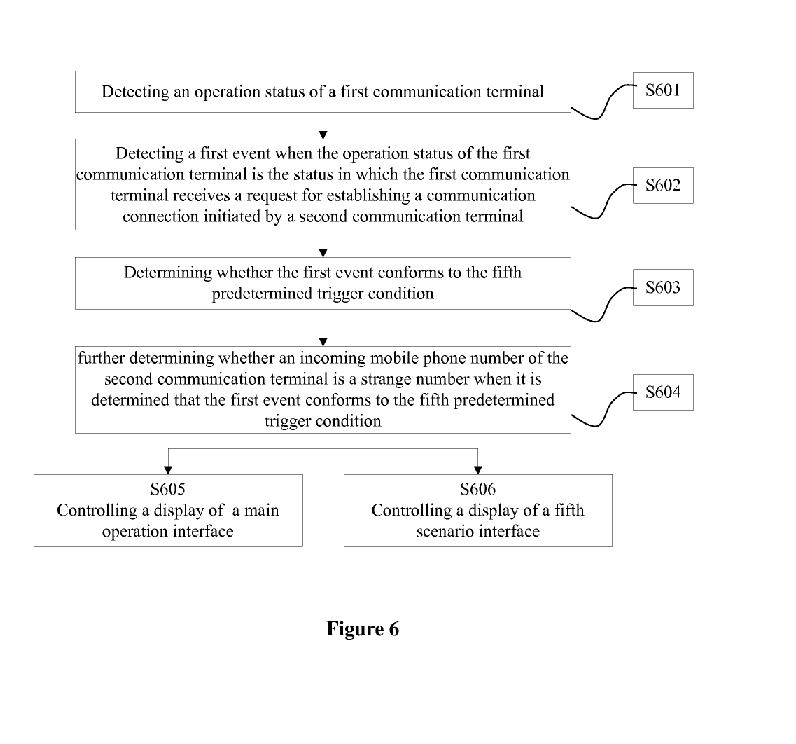

Reference is made to FIG. 6, which is a flowchart of the method for controlling interface display according to a sixth embodiment of the present invention.

S601, detecting an operation status of a first communication terminal.

S602, detecting a first event when the operation status of the first communication terminal is the status in which the first communication terminal receives a request for establishing a communication connection initiated by a second communication terminal.

S603, determining whether the first event conforms to the fifth predetermined trigger condition.

In the sixth embodiment of the present invention, whether the first event conforms to the fifth predetermined trigger condition is determined according to a communication status between the first communication terminal and the second communication terminal. It is determined that the first event confirms to the fifth predetermined trigger condition when the communication status between the first communication terminal and the second communication terminal is the status in which the communication connection is disconnected after the communication connection is successfully established between the first communication terminal and the second communication terminal. Specifically, as described above, when determining the operation status of the first communication terminal as the status in which the communication connection is disconnected after the communication connection is successfully established between the first communication terminal and the second communication terminal, the system performs the determination according to the instruction returned by the Communication Network Protocol. In the Communication Network Protocol, a corresponding instruction, according to which the current communication status between the first communication terminal and the second communication terminal may be determined, may be returned when the communication is disconnected after being connected successfully. Optionally, the communication status between the first communication terminal and the second communication terminal may be determined by detecting whether the first communication terminal performs a third operation that is an operation of answering a call, then whether the first event conforms to the predetermined trigger condition is determined, and thus the scenario interface to be display is decided.

S604, further determining whether an incoming mobile phone number of the second communication terminal is a strange number when it is determined that the first event conforms to the fifth predetermined trigger condition. If the incoming mobile phone number of the second communication terminal is a strange number, the process proceeds to S606; and if the incoming mobile phone number of the second communication terminal is not a strange number, the process proceeds to S605.

Specifically, whether the incoming mobile phone number of the second communication terminal is a strange number may be determined by comparing the incoming mobile phone number with the phone numbers in the address book of the first communication terminal. If the incoming mobile phone number is a strange number, the process proceeds to S606 directly, that is, to display a fifth scenario interface. And if the incoming mobile phone number is not a strange number, a first scenario interface, that is, a main operation interface can be displayed.

S605, controlling a display of a first scenario interface, that is a main operation interface.

S606, controlling a display of a fifth scenario interface.

Specifically, the fifth scenario interface may be an interface for saving contact information. Since the subscriber may want to save the incoming mobile phone number after the subscriber with the first communication terminal talks with the subscriber with the second communication terminal, controlling may be further performed to display the interface for saving the contact information after the incoming mobile phone number is determined as a strange number according to auxiliary information namely contact information.

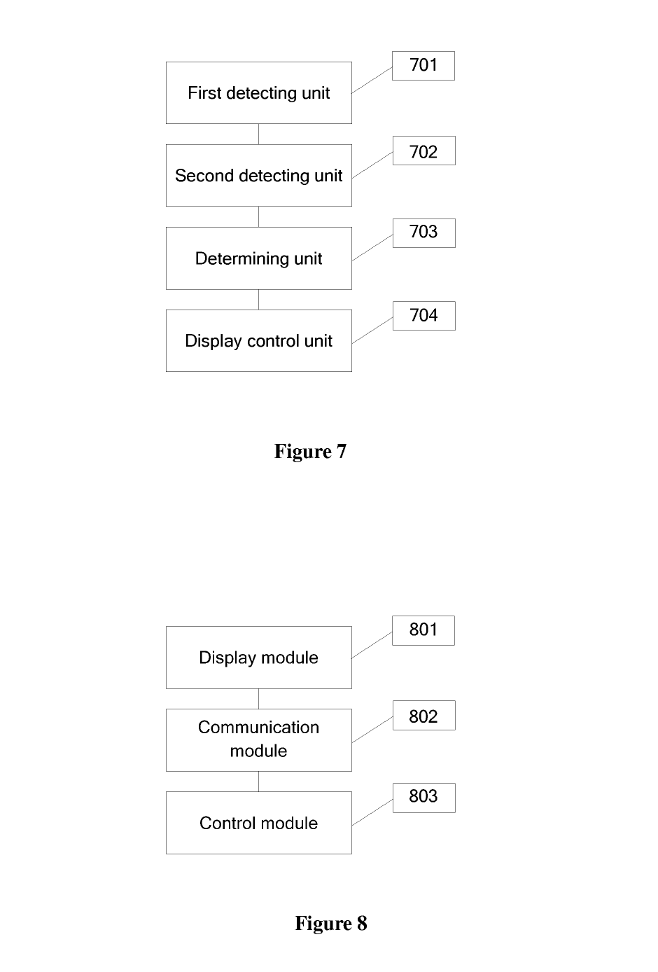

Reference is made to FIG. 7, which is a schematic diagram showing an apparatus for controlling interface display according to an embodiment of the present invention.

An apparatus for controlling interface display, applied to a first communication terminal, includes:

a first detecting unit 701, configured to detect an operation status of the first communication terminal.

a second detecting unit 702, configured to detecting a first event when the operation status of the first communication terminal is a first status in which there is a request for communication connection between the first communication terminal and a second communication terminal.

Specifically, the first status is the status in which there is a request for communication connection between the first communication terminal and the second communication terminal, which includes:

(1) a status in which the first communication terminal initiates a request for establishing a communication connection with the second communication terminal;

(2) a status in which the first communication terminal receives a request for establishing a communication connection initiated by the second communication terminal.

a determining unit 703, configured to determine whether the first event associated with a communication status between the first communication terminal and the second communication terminal conforms to a predetermined trigger condition.

a display control unit 704, configured to control a display of a scenario interface corresponding to the predetermined trigger condition according to a predetermined corresponding relation between the trigger condition and the scenario interface if it is determined that the first event conforms to the trigger condition.

Specifically, when the first status of the first communication terminal is the status in which the first communication terminal initiates the request for establishing the communication connection with the second communication terminal, the communication status between the first communication terminal and the second communication terminal includes:

(1) a status in which the communication connection between the first communication terminal and the second communication terminal is disconnected after the communication connection is established successfully.

(2) a status in which the communication connection fails to be established between the first and the second communication terminals, which may in turn include any one of the following:

A, a status in which the first communication terminal triggers to give up the request for establishing the communication connection;

B, a status in which the second communication terminal triggers to refuse the request for establishing the communication connection;

C, a status in which a network communication device triggers to disconnect the request for the communication connection. Here, the network communication device may be an intermediate device such as a BS and an MSC. The intermediate device may disconnect the request for communication connection initiatively in the case that the signal is weak, the second communication terminal is power off, the second communication terminal is busy or the waiting time is too long.

When the first status of the first communication terminal is the status in which the first communication terminal receives the request for establishing the communication connection initiated by the second communication terminal, the communication status between the first communication terminal and the second communication terminal includes:

(1) a status in which the communication connection between the first communication terminal and the second communication terminal is disconnected after the communication connection is established successfully; and

(2) a status in which the communication connection fails to be established between the first and the second communication terminals, which may in turn include any one of the following statuses:

A, a status in which the first communication terminal triggers to refuse the request for establishing the communication connection; and

B, a status in which the network communication device triggers to disconnect the request for the communication connection.

Corresponding to the various communication statuses between the first communication terminal and the second communication terminal, the first event may includes any one of the following:

an event in which the communication connection is disconnected after the communication connection is successfully established between the first and the second communication terminals;

an event in which the first communication terminal triggers to give up the request for establishing the communication connection;

an event in which the second communication terminal triggers to refuse the request for establishing the communication connection; and

an event in which the network communication device triggers to disconnect the request for the communication connection.

Further, the determining unit specifically may be a first determining unit, configured to determine whether the communication status between the first communication terminal and the second communication terminal is the status in which the communication connection is disconnected after the communication connection is successfully established between the first and the second communication terminals.

Correspondingly, the display control unit is a first display control unit, configured to receive a determined result from the first determining unit, and control a display of a first scenario interface which is a main operation interface. Specifically, the first scenario interface is the main operation interface. Here, the main operation interface is a first interface displayed after a communication terminal is powered on, and can also be referred to as a desktop, a main interface of the communication terminal or the like.

Further, the determining unit specifically may be a second determining unit, configured to determine whether the communication status between the first communication terminal and the second communication terminal is the status in which the first communication terminal triggers to give up the request for establishing the communication connection, or the status in which the network communication device triggers to disconnect the request for the communication connection and so that the communication connection with the second communication terminal is disconnected when the first status of the first communication terminal is the status in which the first communication terminal initiates the request for establishing the communication connection with the second communication terminal.

Correspondingly, the display control unit is a second display control unit, configured to receive a determined result from the second determining unit, and control a display of a second scenario interface which is a dialing interface, an address book interface, a communication history interface or any combination thereof.

Specifically, the second scenario interface may the dialing interface, the address book interface, the communication history interface or any combination thereof. In the case that the first communication terminal initiates the request for establishing the communication connection with the second communication terminal, if the communication connection is disconnected by the first communication terminal initiatively due to non-response of the second communication terminal for a long time, or, by the intermediate network communication device (BS, MSC, or the like) due to the weak signal or the over-long waiting time, the subscriber may want to re-establish the communication connection with the second communication terminal, thus the dialing interface may be displayed so as to facilitate the redialing by the subscriber.

Correspondingly, the address book interface may also be displayed. Since the disconnect of the request for the communication connection is triggered by the first communication terminal initiatively or by the network communication device, the communication connection fails to be established between the first and the second communication terminals, and then the subscriber with the first communication terminal may want to re-establish the connection with the second communication terminal. Thus, the address book interface may be displayed so as to facilitate the dialing of the subscriber. Further, all contact information of the second communication terminal may be acquired and displayed in the second interface alone or in a prioritized way. Further, the contact information other than the information used for establishing the connection for the first time may be displayed in the second interface in a prioritized way. For example, the first communication terminal initiates the request for establishing the communication connection with the second communication terminal by dialing a mobile phone number of the second communication terminal, thus, the contact information of the second communication terminal other than the mobile phone number, such as a landline number or a personal access system (PAS) number, may be displayed in the second interface in a prioritized way.

Correspondingly, controlling may be performed to display the communication history interface, so as to facilitate the redialing of the subscriber. Further, in a possible case, the second interface may be a combination of any two of the above interfaces, for example the combination of the dialing interface and the communication history interface, which is not limited in the present invention.

Further, the determining unit may be a third determining unit, configured to determine whether the communication status between the first communication terminal and the second communication terminal is the status in which the second communication terminal triggers to refuse the request for establishing the communication connection, when the first status of the first communication terminal is the status in which the first communication terminal initiates the request for establishing the communication connection with the second communication terminal.

Correspondingly, the display control unit is a third display control unit, configured to receive a determined result from the third determining unit, and control a display of a third scenario interface such as a short message editing interface, a mail editing interface or an instant communication software interface.

Specifically, in the case that the first communication terminal initiates the request for establishing the communication connection which the second communication terminal, when the second communication terminal triggers to disconnect the request for the communication connection initiatively, that is, the second communication terminal refuses to answer the phone, the subscriber may want to contact with the second communication terminal by a short message, a mail, or the like. Thus, controlling may be performed to display the short message editing interface, the mail editing interface, the instant message software interface (e.g. QQ, MSN) or the like. Further, the contact information of the person corresponding to the second communication terminal is acquired and added into the third scenario interface. For example, mobile phone number of the person corresponding to the second communication terminal is acquired from the address book and added into the addressee number option in the short message editing interface, so that the subscriber has no need to find out and add the addressee number manually. For another example, a mail address of the contact person corresponding to the second communication terminal is acquired and filled into the address bar in the mail editing interface, so that the subscriber has no need to fill the mail address manually. For yet another example, other account numbers such as a QQ number or a MSN number of the contact person corresponding to the second communication terminal are acquired, and a chatting history interface with the contact person corresponding to the second communication terminal may be further acquired after logging in the instant communication software, and the editing interface for chatting with the contact person corresponding to the second communication terminal is directly displayed in the lower window.

Further, the determining unit may be a fourth determining unit, configured to determine whether the communication status between the first communication terminal and the second communication terminal is the status in which the first communication terminal rejects the request for establishing the communication connection from the second communication terminal, when the first status of the first communication terminal is the status in which the first communication terminal receives the request for establishing the communication connection initiated by the second communication terminal.

Correspondingly, the display control unit is a fourth display control unit, configured to receive a determined result from the fourth determining unit, and control a display of a predetermined fourth scenario interface.

The apparatus further includes:

a first executing unit, configured to accept a selecting operation of a subscriber, and send a short message of a content corresponding to the selecting operation of the subscriber to the second communication terminal; and

a second executing unit, configured to send a short message of a predetermined content to the second communication terminal.

Specifically, in the case that a call is handed up when it is not convenient for the subscriber with the to answer the call, controlling may be performed to display the fourth scenario interface, which may be a short message editing interface, a short message selecting interface, a sending confirmation interface or the like. Optionally, the fourth scenario interface may be the short message editing interface, thus it is convenient for the subscriber to explain the reason of hanging up the call by sending a corresponding short message to the second communication terminal.

The fourth scenario interface may also be an interface for displaying a preset short message list. Specifically, several response messages such as “I am in meeting”, “I am in class”, “I am not convenient to answer and will call you later”, may be preset by the terminal or the subscriber, and the subscriber may decide which short message is to be sent to the second communication terminal. Further, after the fourth scenario interface that is short message selecting interface is displayed, a second operation is performed by the first executing unit. The first executing unit receives the selecting operation of the subscriber and sends a short message of the content corresponding to the selecting operation of the subscriber to the second communication terminal.

The fourth scenario interface may be the sending confirmation interface. Specifically, a default short message sent when a phone call is rejected may be set by the subscriber. The fourth scenario interface including the default short message and the contact information of the second communication terminal is displayed directly after the first event occurs, and whether the message should be sent is determined by the subscriber. The second executing unit sends the short message with the predetermined content to the second communication terminal after receiving the conformation operation of the subscriber.

Reference is made to FIG. 8, which is a schematic diagram showing a communication terminal according to an embodiment of the present invention.

The communication terminal includes:

a display module 801, configured to display a scenario interface. Specifically, the display module may be a screen of the communication terminal, such as a touch screen.

a communication module 802, configured to establish a communication connection with a second communication terminal for communication. The communication module may be a radio frequency (RF) path which is used to communicate with other terminals.

a control module 803, configured to detect an operation status of the communication terminal; to detect a first event when the operation status of the communication terminal is a first status in which there is a request for communication connection between the communication module and the second communication terminal; to determine whether the first event associated with a communication status between the communication module and the second communication terminal conforms to a predetermined trigger condition; to control the display module to display a scenario interface corresponding to the predetermined trigger condition according to the predetermined corresponding relation between the trigger condition and the scenario interface if it is determined that the first event conforms to the trigger condition.

Specifically, the control module may includes:

a first detecting unit, configured to detect an operation status of a first communication terminal;

a second detecting unit, configured to detect a first event when the operation status of the first communication terminal is a first status in which there is a request for communication connection between the first communication terminal and a second communication terminal;

a determining unit, configured to determine whether the first event associated with a communication status between the first communication terminal and the second communication terminal conforms to a predetermined trigger condition;

a display control unit, configured to control a display of a scenario interface corresponding to a predetermined trigger condition according to the predetermined corresponding relation between the trigger condition and the scenario interface if it is determined that the first event conforms to the trigger condition.

It should be noted that the relationship terminologies such as first and second and the like are only used herein to distinguish an entity or operation from another entity or operation, and it does not necessitate or imply that there is such relationship or order between those entities and operations. Moreover, the terminologies of “comprise”, “include”, and any other variants are intended to cover the non-exclusive inclusion. Therefore, the process, method, article or device including a series of elements includes not only those elements but also other elements that are not enumerated, or also include the elements inherent for the process, method, article or device. In the case of no additional restrictions, the statement “comprising (including) one . . . ” does not exclude that the case that other elements also exist in the process, method, article or device.

The present invention may be described in the general context of the computer executable instruction executed by the computer, such as a program module. Generally, the program module includes a routine, a program, an object, a component, a data structure or the like, which executes a particular task or implements a particular abstract data type. The present invention may also be implemented in a Distributed Computing Environment, in which the task is executed by remote processing device connected via the communication network. In the Distributed Computing Environment, the program module may be located in a storage medium including storage device, of a local or remote computer.

The above are only particular embodiments of the present invention, it should be understood that many improvements and retouches can be made by those skilled in the art without deviating from the principles of the present invention, which fall in the scope of protection of the present invention.

1. A method for controlling interface display, applied in a first communication terminal, the method comprising:
detecting an operation status of the first communication terminal;
detecting a first event in a case that the operation status of the first communication terminal is a first status in which there is a request for a communication connection between the first communication terminal and a second communication terminal;
determining whether the first event associated with a communication status between the first communication terminal and the second communication terminal conforms to a predetermined trigger condition; and
controlling a display of a scenario interface corresponding to the predetermined trigger condition according to a predetermined corresponding relation between the trigger condition and the scenario interface, if it is determined that the first event conforms to the trigger condition.

2. The method according to claim 1, wherein the status in which there is the request for the communication connection between the first communication terminal and the second communication terminal comprises:
a status in which the first communication terminal initiates a request for establishing the communication connection with the second communication terminal.

3. The method according to claim 2, wherein the communication status between the first communication terminal and the second communication terminal comprises:
a status in which the communication connection is disconnected after the communication connection is successfully established between the first and the second communication terminals; or
a status in which the communication connection fails to be established between the first and the second communication terminals.

4. The method according to claim 3, wherein in a case that the communication status between the first communication terminal and the second communication terminal is detected as the status in which the communication connection is disconnected after the communication connection is successfully established between the first and the second communication terminals, controlling the display of the scenario interface corresponding to the trigger condition according to the predetermined corresponding relation between the trigger condition and the scenario interface comprises:
controlling a display of a first scenario interface which is a main operation interface.

5. The method according to claim 3, wherein the status in which the communication connection fails to be established between the first and the second communication terminals comprises any one of the following:
a status in which the first communication terminal triggers to give up the request for establishing the communication connection;
a status in which the second communication terminal triggers to refuse the request for establishing the communication connection;
a status in which a network communication device triggers to disconnect the request for the communication connection.

6. The method according to claim 5, wherein in a case that the status in which the communication connection fails to be established between the first and the second communication terminals is the status in which the first communication terminal triggers to give up the request for establishing the communication connection or the status in which the network communication device triggers to disconnect the request for the communication connection, controlling the display of the scenario interface corresponding to the trigger condition according to the predetermined corresponding relation between the trigger condition and the scenario interface comprises:
controlling a display of a second scenario interface which is a dialing interface, an address book interface, a communication history interface or any combination thereof.

7. The method according to claim 5, wherein in a case that the status in which the communication connection fails to be established between the first and the second communication terminals is the status in which the second communication terminal triggers to refuse the request for establishing the communication connection, controlling the display of the scenario interface corresponding to the trigger condition according to the predetermined corresponding relation between the trigger condition and the scenario interface comprises:
controlling a display of a third scenario interface which is a short message editing interface, a mail editing interface or an instant communication software interface.

8. The method according to claim 1, wherein the status in which there is the request for the communication connection between the first communication terminal and the second communication terminal comprises:
a status in which the first communication terminal receives a request for establishing the communication connection initiated by the second communication terminal.

9. The method according to claim 8, wherein in a case that the communication status between the first communication terminal and the second communication terminal is a status in which the first communication terminal rejects the request for establishing the communication connection initiated by the second communication terminal, controlling the display of the scenario interface corresponding to the trigger condition according to the predetermined corresponding relation between the trigger condition and the scenario interface comprises:
controlling a display of a predetermined fourth scenario interface and performing a second operation.

10. The method according to claim 9, wherein the performing the second operation comprises:
accepting a selecting operation of a subscriber, and sending a short message with a content corresponding to the selecting operation of the subscriber to the second communication terminal; or
sending a short message with a predetermined content to the second communication terminal.

11. The method according to claim 1, further comprising, after it is determined that the first event conforms to the predetermined trigger condition, and before controlling a display of a scenario interface corresponding to the predetermined trigger condition according to a predetermined corresponding relation between the trigger condition and the scenario interface:
determining the scenario interface to be displayed further according to auxiliary information.

12. An apparatus for controlling interface display, provided in a first communication terminal, the apparatus for controlling interface display comprising:
a first detecting unit, configured to detect an operation status of the first communication terminal;
a second detecting unit, configured to detect a first event in a case that the operation status of the first communication terminal is a first status in which there is a request for a communication connection between the first communication terminal and a second communication terminal;
a determining unit, configured to determine whether the first event associated with a communication status between the first communication terminal and the second communication terminal conforms to a predetermined trigger condition; and
a display control unit, configured to control a display of a scenario interface corresponding to the predetermined trigger condition according to a predetermined corresponding relation between the trigger condition and the scenario interface if it is determined that the first event conforms to the trigger condition.

13. The apparatus according to claim 12, wherein the status in which there is the request for the communication connection between the first communication terminal and the second communication terminal comprises:
a status in which the first communication terminal initiates a request for establishing a communication connection with the second communication terminal.

14. The apparatus according to claim 13, wherein:
the determining unit is a first determining unit, which is configured to determine whether the communication status between the first communication terminal and the second communication terminal is a status in which the communication connection is disconnected after the communication connection is successfully established between the first and the second communication terminals; and
the display control unit is a first display control unit, which is configured to receive a determined result from the first determining unit, and control a display of a first scenario interface which is a main operation interface.

15. The apparatus according to claim 13, wherein:
the determining unit is a second determining unit, which is configured to determine whether the communication status between the first communication terminal and the second communication terminal is a status in which the first communication terminal triggers to give up the request for establishing the communication connection, or, a status in which a network communication device triggers to disconnect the request for the communication connection;
the display control unit is a second display control unit, which is configured to receive a determined result from the second determining unit, and control a display of a second scenario interface which is a dialing interface, an address book interface, a communication history interface or any combination thereof.

16. The apparatus according to claim 13, wherein:
the determining unit is a third determining unit, which is configured to determine whether the communication status between the first communication terminal and the second communication terminal is a status in which the second communication terminal triggers to refuse the request for establishing the communication connection; and
the display control unit is a third display control unit, which is configured to receive a determined result from the third determining unit, and control a display of a third scenario interface which is a short message editing interface, a mail editing interface or an instant communication software interface.

17. The apparatus according to claim 12, wherein the status in which there is the request for the communication connection between the first communication terminal and the second communication terminal comprises:
a status in which the first communication terminal receives a request for establishing the communication connection initiated by the second communication terminal.

18. The apparatus according to claim 17, wherein:
the determining unit is a fourth determining unit, which is configured to determine whether the communication status between the first communication terminal and the second communication terminal is a status in which the first communication terminal rejects the request for establishing the communication connection initiated by the second communication terminal;
the display control unit is a fourth display control unit, which is configured to receive a determined result from the fourth determining unit, and control a display of a predetermined fourth scenario interface.

19. The apparatus according to claim 18, further comprising:
a first executing unit, configured to accept a selecting operation of a subscriber, and send a short message with a content corresponding to the selecting operation of the subscriber to the second communication terminal; and
a second executing unit, configured to send a short message with a predetermined content to the second communication terminal.

20. A communication terminal comprising:
a display module, configured to display a scenario interface;
a communication module, configured to establish a communication connection with a second communication terminal for communication;
a control module, configured to detect an operation status of the communication terminal; to detect a first event in a case that the operation status of the communication terminal is a first status in which there is a request for the communication connection between the communication module and a second communication terminal; to determine whether the first event associated with a communication status between the communication module and the second communication terminal conforms to a predetermined trigger condition; to control the display module to display a scenario interface corresponding to the predetermined trigger condition according to a predetermined corresponding relation between the trigger condition and the scenario interface if it is determined that the first event conforms to the trigger condition.
